(19) United States
(12) Patent Application Publication
(10) Pub. No.: US 2010/0098364 A1
(43) Pub. Date: Apr. 22, 2010

(54) ROLLER WITH CAGE ASSEMBLY

(76) Inventor: Izumi Ohashi, Shizuoka (JP)

Correspondence Address: CLARK & BRODY, 1090 VERMONT AVENUE, NW, SUITE 250, WASHINGTON, DC, 20005, US

(21) Appl. No.: 12/529,370

(22) PCT Filed: Feb. 7, 2008
(86) PCT No.: PCT/JP2008/052025

§ 371 Date: Sep. 1, 2009

(30) Foreign Application Priority Data
Mar. 2, 2007 (JP) 2007-052930

(51) Int. Cl. F16C 19/26; F16C 33/34; F16C 33/46

(52) U.S. Cl. 384/450

(57) ABSTRACT

A roller with cage assembly 11 comprises a plurality of crowned rollers 12 each including a column part 12a having a constant diameter and inclined parts 12b connected to both sides of the column part 12a and inclined to reduce the diameter gradually, and a cage 13 having a pair of ring parts 14 and 15, a plurality of pillar parts 16 connecting the pair of ring parts to each other, pockets 17 formed between the adjacent pillar parts 16 to house the rollers 12, and guiding surfaces 16d having a predetermined width in a radial direction on wall surfaces of the pillar parts 16 opposed to the column part 12a. Thus, when it is assumed that a length from an end face 12c of the roller 12 to the boundary part between the column part 12a and the inclined part 12b is Dp, and an axial shortest distance from the wall surface of the pocket 17 opposed to the end face 12c of the roller 12 to the guiding surface 16d is A, the relation between them satisfies that Dp<A.

### TECHNICAL FIELD

The present invention relates to a roller with cage assembly and more particularly, to a roller with cage assembly provided with rollers each having an inclined part.

### BACKGROUND ART

A conventional roller with cage assembly is disclosed in Japanese Unexamined Patent Publication No. 2000-240662, for example. The roller with cage assembly disclosed in the above document comprises a plurality of rollers, and a cage having a pair of rings and a plurality of pillar parts connecting the pair of rings to each other and pockets formed between the adjacent pillar parts to retain the rollers.

The above roller with cage assembly employs crowned rollers each having a column part having a constant diameter at its center region and inclined parts at both sides of the column part to avoid an edge load with an opponent member in some cases. In addition, guiding surfaces for the rollers are formed at wall surfaces of the pillar parts in the pockets.

According to the above roller with cage assembly, when a boundary part between the column part and the inclined part comes in contact with the guiding surface, the roller is likely to be skewed. In this case, when a space between the roller and the cage is out of oil film, the guiding surface is worn. As a result, worn powder contaminates a lubricant agent, and further abrasion is caused between the roller and the cage, which could cause a bearing life to be shortened.

### DISCLOSURE OF THE INVENTION

Thus, it is an object of the present invention to provide a roller with cage assembly having a long life by guiding rollers stably.

A roller with cage assembly according to the present invention comprises a plurality of crowned rollers each including a column part having a constant diameter and inclined parts connected to both sides of the column part and inclined to reduce the diameter gradually, and a cage having a pair of ring parts, a plurality of pillar parts connecting the pair of ring parts to each other, pockets formed between the adjacent pillar parts to house the rollers, and guiding surfaces having a predetermined width in a radial direction at wall surfaces of the pillar parts opposed to the column part. Thus, when it is assumed that a length from the end face of the roller to the boundary part between the column part and the inclined part is Dp, and an axial shortest distance from the wall surface of the pocket opposed to the end face of the roller to the guiding surface is A, the relation between them satisfies that Dp<A.

According to the above construction, since the boundary part between the column part and the inclined part can be prevented from coming to contact with the guiding surface in the normal rotation state, the roller can be effectively prevented from being skewed, so that the roller can be stably guided. As a result, abrasion due to running out of the oil film can be prevented, so that the life of the roller with cage assembly can be lengthened. In addition, since the roller is prevented from being skewed, vibration can be small at the time of the rotation of the bearing.

Preferably, when it is assumed that a maximum gap formed between the end face of the roller and the wall surface of the pocket opposed to the end face of the roller is δ, the relation among the above dimensions satisfies that Dp+δ<A. Thus, even when the roller is deflected in one direction in the pocket to a maximum extent, the boundary part between the column part and the inclined part does not come in contact with the guiding surface. As a result, the roller can be prevented from being skewed further effectively.

According to one embodiment, the cage has first linear parts at its both ends so as to be positioned on the radial outer side of the cage, a second linear part at its center part so as to be positioned on the radial inner side of the cage and to be parallel to the first linear parts, and connection parts extending so as to connect the first linear parts to the second linear part. The guiding surfaces are provided at the connection parts.

According to another embodiment, the cage is guided by an inner diameter surface of an outer member of a supporting part.

According to the present invention, the life of the roller with cage assembly can be lengthened by adjusting the length of the inclined part so that the boundary part between the column part and the inclined part may not come in contact with the guiding surface.

### BRIEF DESCRIPTION OF THE DRAWINGS

FIG. 1 is a view showing a roller with cage assembly according to one embodiment of the present invention;

FIG. 2 is a view showing a roller in FIG. 1;

FIG. 3 is a sectional view showing a cage in FIG. 1; and

FIG. 4 is a perspective view showing the cage in FIG. 1.

### BEST MODE FOR CARRYING OUT THE INVENTION

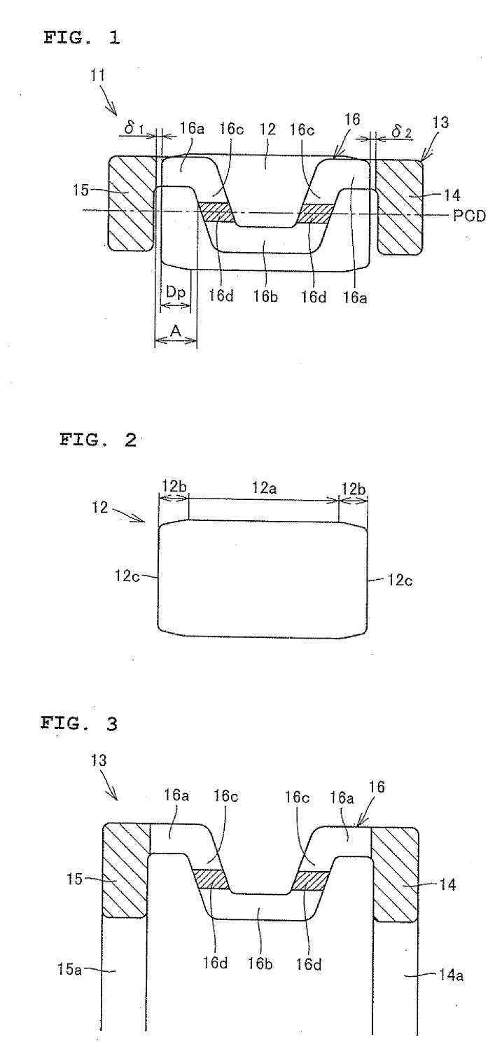

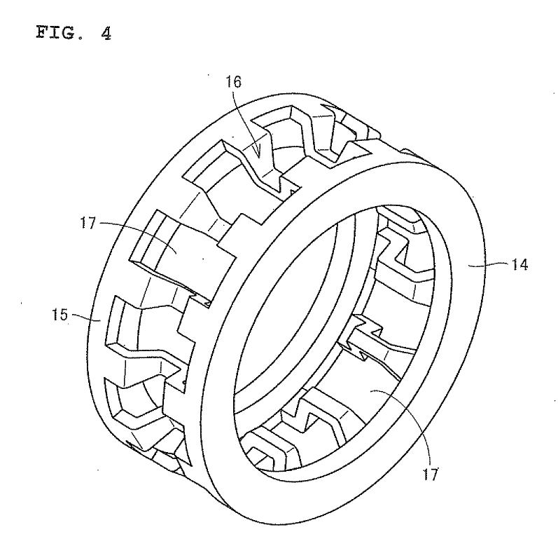

A roller with cage assembly 11 according to one embodiment of the present invention will be described with reference to FIGS. 1 to 4. FIG. 1 is a view showing the roller with cage assembly 11, FIG. 2 is a view showing a roller 12, FIG. 3 is a sectional view showing a cage 13, and FIG. 4 is a perspective view showing the cage 13. First, referring to FIG. 1, the roller with cage assembly 11 is a cage and roller type of needle roller bearing comprising the plurality of rollers 12, and the cage 13 for retaining intervals of the adjacent rollers 12.

Referring to FIG. 2, the roller 12 is partially crowned and includes a column part 12a having a constant diameter and inclined parts 12b at both ends of the column part 12a. The inclined part 12b is formed such that the diameter is gradually reduced from the column part 12a toward an end face 12c.

Referring to FIGS. 3 and 4, the cage 13 includes a pair of ring parts 14 and 15, a plurality of pillar parts 16 connecting the pair of ring parts 14 and 15, and pockets 17 formed between the adjacent pillar parts 16 to house the rollers 12.

The ring parts 14 and 15 are annular members having through holes 14a and 15a penetrating in their thickness direction at the center, respectively.

The pillar part 16 includes first linear parts 16a at its both ends so as to be positioned on the radial outer side of the cage 13, a second linear part 16b at its center so as to be positioned on the radial inner side of the cage 13 and to be parallel to the first liner parts 16a, and connection parts 16c extending so as to connect the first linear parts 16a and the second linear part 16b.

The first linear part 16a is provided with a first roller stopper (not shown) to prevent the roller 12 housed in the pocket 17 from escaping in a radial outer direction and the second linear part 16b is provided with a second roller stopper (not shown) to prevent the roller 12 housed in the pocket 17 from escaping in a radial inner direction. In addition, the connection part 16c is provided with a guiding surface 16d on a wall surface opposed to the column part 12a of the roller 12. This guiding surface 16d is in contact with the column part 12a of the roller 12 to guide the rotation of the roller 12. In addition, since a predetermined gap is provided between the roller 12 and the wall surface of the pocket 17, the cage 16 can be moved in the radial direction to some extent. Thus, the guiding surface 16d has a predetermined width in the radial direction of the cage 16 so that the roller 12 can be always in contact with the guiding surface 16d.

The above cage 13 is an M-shaped cage in which a sectional configuration formed by the ring parts 14 and 15 and the pillar part 16 is M shape. In addition, when the roller with cage assembly 11 is incorporated in a supporting part, the cage 13 is guided by an inner diameter surface of an outer member.

Referring to FIG. 1, the guiding surface 16d of the cage 13 guides the rotation of the roller 12 at a position containing the PCD (pitch circle diameter) of the roller 12. Thus, when it is assumed that a length from the end face 12c of the roller 12 to the boundary part between the column part 12a and the inclined part 12b is Dp, and a shortest distance from the wall surface of the pocket 17 opposed to the end face 12c of the roller 12 to the guiding surface 16d is A, each dimension is set so as to satisfy that Dp<A.

Thus, the boundary part between the column part 12a and the inclined part 12b can be prevented from being in contact with the guiding surface 16d during the normal rotation of the roller with cage assembly 11. Thus, the column part 12a has surface contact with the guiding surface 16d and the roller 12 can be effectively prevented from being skewed, so that the roller 12 can be stably guided. As a result, abrasion due to running out of the oil film can be prevented, and the life of the roller with cage assembly 11 can be lengthened. In addition, when the roller 12 is prevented from being skewed, vibration can be small at the time of the rotation of the bearing.

Further preferably, when it is assumed that a maximum gap formed between the end face 12c of the roller 12 and the wall surface of the pocket 17 opposed to the end face 12c of the roller 12 is δ (that is, “δ₁+δ₂” in FIG. 1), each dimension is set so as to satisfy Dp+δ<A.

Thus, even when the roller 12 is deflected in one direction in the pocket 17 to a maximum extent, the boundary part between the column part 12a and the inclined part 12b does not come in contact with the guiding surface 16d. As a result, the roller 12 can be prevented from being skewed further effectively.

In addition, it is necessary to satisfy the above dimensional relation at all the positions of the guiding surface 16d in the radial direction (vertical direction in FIG. 3) to prevent the roller 12 from being skewed effectively. Consequently, it is only necessary to satisfy the above dimensional relation at a position in which the dimension A shows a minimum value (uppermost part of the guiding surface 16d in FIG. 3).

In addition, although the roller with cage assembly 11 is the needle roller bearing in the above, it may be a bar type roller bearing or a cylindrical roller bearing. In addition, although the above roller with cage assembly 11 may be incorporated in the supporting part as the cage and roller bearing, it may be incorporated together with an inner ring and/or an outer ring.

In addition, although the cage 13 is guided on its outer diameter side by the inner diameter surface of the outer member in the above example, it may be guided on its inner diameter side by the outer diameter surface of an inner member. In this case, the cage is a W-shaped cage having a sectional configuration of W shape in which a first linear part is positioned on the radial inner side of the cage and a second linear part is position on the radial outer side of the cage. In addition, the cage may be guided by the rollers 12.

In addition, although each of the first linear part 16a and the second linear part 16b is provided with the roller stopper in the above roller with cage assembly 11, since the roller stopper is not an essential part, it can be omitted.

Still furthermore, the above roller with cage assembly 11 can be used for various purposes without limiting usage in particular. For example, it can be used as a bearing for supporting a large end or a small end of a connecting rod.

Although the embodiments of the present invention have been described with reference to the drawings in the above, the present invention is not limited to the above-illustrated embodiments. Various kinds of modifications and variations may be added to the illustrated embodiments within the same or equal scope of the present invention.

### INDUSTRIAL APPLICABILITY

The present invention can be advantageously used for the roller with cage assembly comprising rollers each having the inclined parts.

1. A roller with cage assembly comprising:
a plurality of crowned rollers each including a column part having a constant diameter and inclined parts connected to both sides of said column part and inclined to reduce the diameter gradually, and
a cage having a pair of ring parts, a plurality of pillar parts connecting said pair of ring parts to each other, pockets formed between said adjacent pillar parts to house said rollers, and guiding surfaces having a predetermined width in a radial direction at wall surfaces of said pillar parts opposed to said column part, wherein
when it is assumed that a length from the end face of said roller to the boundary part between said column part and said inclined part is Dp, and an axial shortest distance from the wall surface of said pocket opposed to the end face of said roller to said guiding surface is A, the relation between them satisfies that
Dp<A.

2. The roller with cage assembly according to claim 1, wherein when it is assumed that a maximum gap formed between the end face of said roller and the wall surface of said pocket opposed to the end face of said roller is δ, the relation among the above dimensions satisfies that
Dp+δ<A.

3. The roller with cage assembly according to claim 1, wherein
said cage has first linear parts at its both ends so as to be positioned on the radial outer side of the cage;
a second linear part at its center part so as to be positioned on the radial inner side of the cage and to be parallel to said first linear parts; and
connection parts extending so as to connect said first linear parts to said second linear part, and
said guiding surface is provided at said connection part.

4. The roller with cage assembly according to claim 1, wherein
said cage is guided by an inner diameter surface of an outer member of a supporting part.
